(19) United States
(12) Patent Application Publication
(10) Pub. No.: US 2015/0052606 A1
(43) Pub. Date: Feb. 19, 2015

(54) METHOD AND A SYSTEM TO DETECT MALICIOUS SOFTWARE

(71) Applicants: Francisco Romero Bueno, Madrid (ES); Antonio Manuel Amaya Calvo, Madrid (ES)

(72) Inventors: Francisco Romero Bueno, Madrid (ES); Antonio Manuel Amaya Calvo, Madrid (ES)

(73) Assignee: TELEFONICA, S.A., Madrid (ES)

(21) Appl. No.: 14/357,898

(22) PCT Filed: Dec. 23, 2011
(86) PCT No.: PCT/EP2011/073949

§ 371 Date: Oct. 14, 2014

(30) Foreign Application Priority Data
Oct. 14, 2011 (ES) P201131650

(51) Int. Cl. H04L 29/06

(52) U.S. Cl. CPC H04L 63/1425; H04L 63/145
USPC 726/23

(57) ABSTRACT

In the method of the invention said detection is performed in an Anomaly Detection System, or ADS, by analyzing the behavior of a network and looking for deviations with respect to a normality, said normality indicating common behavior of users of said network and being defined previous to said detection. The method is characterised in that it comprises building a plurality of detection models, each of said plurality of detection models adapted to different entities of said network and to different algorithms, said different algorithms implementing different detection strategies and said plurality of detection models representing said normality. The system of the invention is arranged to implement the method of the invention.

### FIELD OF THE ART

The present invention generally relates, in a first aspect, to a method to detect malicious software, said detection being performed in an Anomaly Detection System, or ADS, by analyzing the behavior of a network and looking for deviations with respect to a normality, said normality indicating common behavior of users of said network and being defined previous to said detection, and more particularly to a method that comprises building a plurality of detection models, each of said plurality of detection models adapted to different entities of said network and to different algorithms, said different algorithms implementing different detection strategies and said plurality of detection models representing said normality.

A second aspect of the invention relates to a system arranged to implement the method of the first aspect.

### PRIOR STATE OF THE ART

Malicious software (malware) detection can be classified in many ways. One of them is the classical categorization that distinguishes between host-based and network-based detection. The first type tries to find evidences of the existence of viruses, Trojans, etc by means of processes, physical memory and several other in-host analysis, while the second focuses on the communications performed by such viruses or Trojans.

Several strategies arose in the early days of the network-based detection. The more basic one was to block certain communications traversing a special network node, a firewall. This solution was useful until malware, in order to hide, started to use wide used protocols such as HTTP, SMTP that cannot be blocked without stopping the business of ISPs and operators.

Then, it was obvious that analyzing a few fields of the TCP/IP packets (protocol, source and destination ports, and IP addresses) was not enough, and it was necessary to extend the monitoring process to the complete TCP/IP header and even the payload of the packets. This was how Network Intrusion Detection Systems (NIDS or IDS) born [15]. IDS are based on traffic signatures, i.e., special strings that, when appear within the network packets, denote the presence of a specific malware. Wide known IDS are Snort [1] and Bro [2].

Although nowadays IDS continue playing an important role in the monitoring processes of operators all around the world, since they address an important percentage of malware detection, researchers found that some malware remained undetectable to firewalls and IDSs. These undetectable viruses, worms, etc. both used popular protocols and a priori normal content within packets payload. Some examples are: spammers [3], denial of service (DoS) oriented bots [4] or scanners [5]. Then, it was seen that the only way to detect these threats was to analyze the behavior of the network in order to find deviations with respect to the normality, i.e., anomalies. The normality is defined through a mathematical representation of the common reality, i.e., a model, which is built in a step previous to the detection. Network Anomaly Detection Systems (NADS) [14] or simply Anomaly Detection Systems (ADS) such as Proventia [6] quickly revealed to be useful covering the mentioned gap in the monitoring field. And also in many other scenarios, such as zero-day malware detection (new existing malware for which IDSs have not a valid signature) or encrypted traffic (signatures has nothing to do when the payload cannot be seen).

Anomaly detection is still an interesting research area that can give lot of solutions for security administrators. Innovative Artificial Intelligence (AI) algorithms are emerging, and the target of the modeling, which sometimes is most important than the detection algorithm itself, varies between the most general granularity, the whole network, to the minimal one, the individual final user.

Two types of problems can be distinguished when talking about existing ADS's, efficacy-related and efficiency-related ones.

Efficacy problems are evident in all companies' every day. Their already deployed systems do not detect everything, and the things they should detect are not properly found due to obsolete strategies and mechanisms.

Per-Network Basis Behavior Modeling

Models regarding the behavior of monitored networks are always aggregation-based, counting the number of packets/flows/bytes per time unit and defining thus a baseline. While it is true that this approach is enough to deal with major treats such as DoS attacks [4], where a big amount of data is generated, it has nothing to do with more discrete and sophisticated attacks based on very low variations of certain traffic characteristics which are only appreciable at the single-entity level.

Rudimentary Detection Algorithms

Condition-consequence rules and volumes/thresholds are almost all the technologies implemented in most of the successful NADS. These are very basic algorithms hard to maintain (new conditions must be considered when a treat evolves), showing very low flexibility (a threshold of 1000000 bytes with rise up when 1000001 bytes are fond) and poor not self-adapting.

Most of the efficiency-related problems regarding existing solutions are due to lack of a common framework for monitoring purposes. Each solution is proprietary and heavily closed to third parties, causing organizations to install a new battery of solutions each time a new treat arises.

Null Integration Level Between Vendors

Except for SIEM's [9], a special kind of systems not in charge of direct network monitoring, but in charge of different sources' events aggregation and correlation, no integration is allowed between current monitoring systems (including ADS's), and not only monitoring systems: sniffing tools, logging applications, etc. For instance, it's very common that IDS's/IPS's/ADS's sniff the network traffic their selves, while a lot of sniffing systems do the same task.

Low Customization/Extension Level

One of the main problems the monitoring systems and ADS's in particular have regarding their architecture is the lack of flexibility. Current commercial and research anomaly detection solutions are heavily closed and proprietary, what makes almost impossible any kind of customization/extension. This low customizing level could seem normal in any other kind of software system, but not in the monitoring field, where the security operators need to face up the continuous evolution of the malware by means of new algorithms, strategies, sources of data, etc.

Multiple Monitoring Points

In addition, if an organization expects to use several NADS (because each one of them targets a different threat) then each individual NADS will require an exclusive monitoring point where to obtain the raw traffic from. This could seem a minor problem if the monitoring points were not costly to provide. On the one hand, physical taping solutions must cut the wire for a few seconds, but enough to stop critical applications, and the division of the optic power must be done very carefully in order to allow the endpoints continue negotiating the link. On the other hand, logical taps such as port mirroring consume a high amount of processing capabilities in the network nodes; additionally, each monitoring application needs an exclusive port in the node.

Monolithic Applications

Finally, existing solutions are designed to run in a single box, avoiding a desirable processing distribution feature. Monolithic applications usually require big amounts of resources such as CPU, RAM memory and disk to deal with high-speed networks.

### DESCRIPTION OF THE INVENTION

It is necessary to offer an alternative to the state of the art which covers the gaps found therein, particularly related to the lack of proposals which really allow detecting all possible malicious software and deploying a common framework for monitoring purposes so that organizations do not need to install a new battery of solutions each time a new treat arises.

To that end, the present invention provides, in a first aspect a method to detect malicious software, said detection being performed in an Anomaly Detection System, or ADS, by analyzing the behavior of a network and looking for deviations with respect to a normality, said normality indicating common behavior of users of said network and being defined previous to said detection.

On contrary to the known proposals, the method of the invention, in a characteristic manner it further comprises building a plurality of detection models, each of said plurality of detection models adapted to different entities of said network and to different algorithms, said different algorithms implementing different detection strategies and said plurality of detection models representing said normality.

Other embodiments of the method of the first aspect of the invention are described according to appended claims 1 to 15, and in a subsequent section related to the detailed description of several embodiments.

A second aspect of the present invention concerns to a system to detect malicious software, said detection being performed in an Anomaly Detection System, or ADS, by analyzing the behavior of a network and looking for deviations with respect to a normality, said normality indicating common reality of said network and being defined previous to said detection.

In the system of the second aspect of the invention, on contrary to the known systems mentioned in the prior state of the art section, and in a characteristic manner it comprises a probe module for traffic monitoring of said network connected to a controller module in charge of performing said detection, wherein said controller module is provided of a plurality of detection models built by means of a compiler module, each of said plurality of detection models adapted to different entities of said network and to different algorithms, said different algorithms implementing different detection strategies and said plurality of detection models representing said normality.

The system of the second aspect of the invention is adapted to implement the method of the first aspect.

Other embodiments of the system of the second aspect of the invention are described according to appended claims 16 to 22, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 shows the components and the interaction between them, said components and interactions defining a possible architecture of the proposed system, according to an embodiment of the present invention.

FIG. 2 shows the probe module, according to an embodiment of the present invention.

FIG. 3 shows the monitor module and the detectors library, according to an embodiment of the present invention.

FIG. 4 shows the compiler module and the compilers library, according to an embodiment of the present invention.

FIG. 5 shows the logger module and the loggers library, according to an embodiment of the present invention.

FIG. 6 shows a possible sequence diagram between the monitor module and the compiler module, wherein the monitor module and the compiler module make use of the monitor-compiler interface, according to an embodiment of the present invention.

FIG. 7 shows the flow chart for DNS-based domain flux detector, according to an embodiment of the present invention.

FIG. 8 shows a graphical-based representation of clusters when using the suspicious traffic clustering, wherein normal vectors are represented by “0”, anomalies by “x” and clusters by circles, according to an embodiment of the present invention.

FIG. 9 shows a 2-features graphical representation of the quick cluster belonging algorithm, according to an embodiment of the present invention.

FIG. 10 shows an example of distributed physical deployment of the system components, according to an embodiment of the present invention.

### DETAILED DESCRIPTION OF SEVERAL EMBODIMENTS

The proposed invention regards to hardware and software equipment (or set of equipments if its components are finally distributed) acting as a platform allowing much more efficacy and efficiency in the network anomaly detection field.

The efficacy gain is obtained thanks to the combination of two innovative approaches:
The usage of detection models in a per-user fashion. Instead of creating a single model for a whole network, each entity within it is modeled.
The usage of detection models in a per-algorithm fashion. Instead of having a unique detection strategy, multiple detector instances run in parallel.

The above two approaches can be seen as a model matrix where N entities (E₁ . . . E_{N}) and M algorithms (A₁ . . . A_{M}) are considered, obtaining N×M different models (M₁₁ . . . M_{NM}.

Model and their respective detectors can be either state of art ADS (they can be considered simple 1×1 matrices, since a single modeled entity and just one algorithm are used) or innovative detection algorithms, as the two Artificial Intelligence-based later explained.

In addition, other architectural features available in the proposed invention allow much more efficiency in terms of:
The distribution of the processing effort between several physical nodes.
Easy integration of existing monitoring-related software, such a as network traffic processors, by architectural-design.
A single monitoring point in the network.

Architecture Components

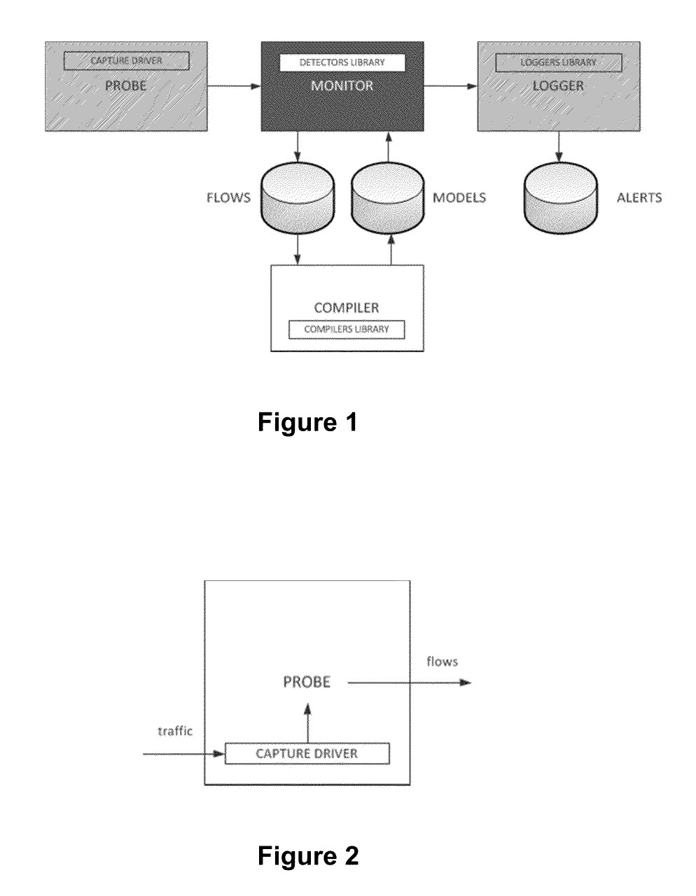

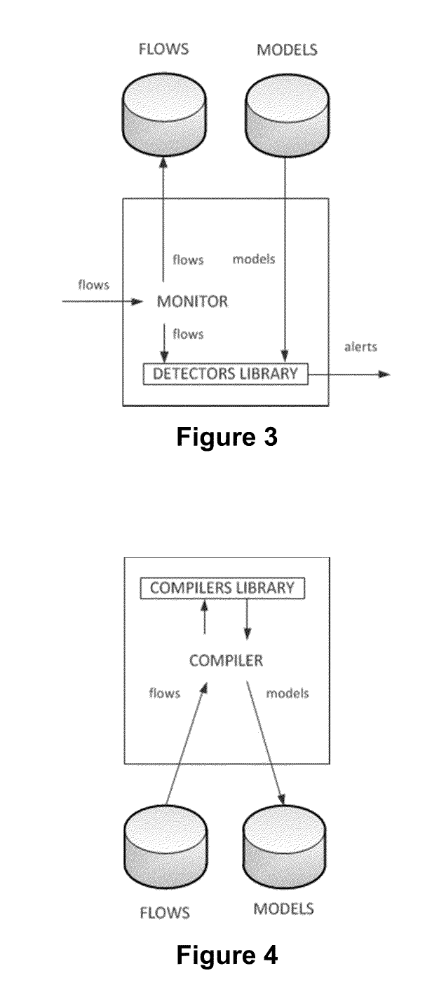

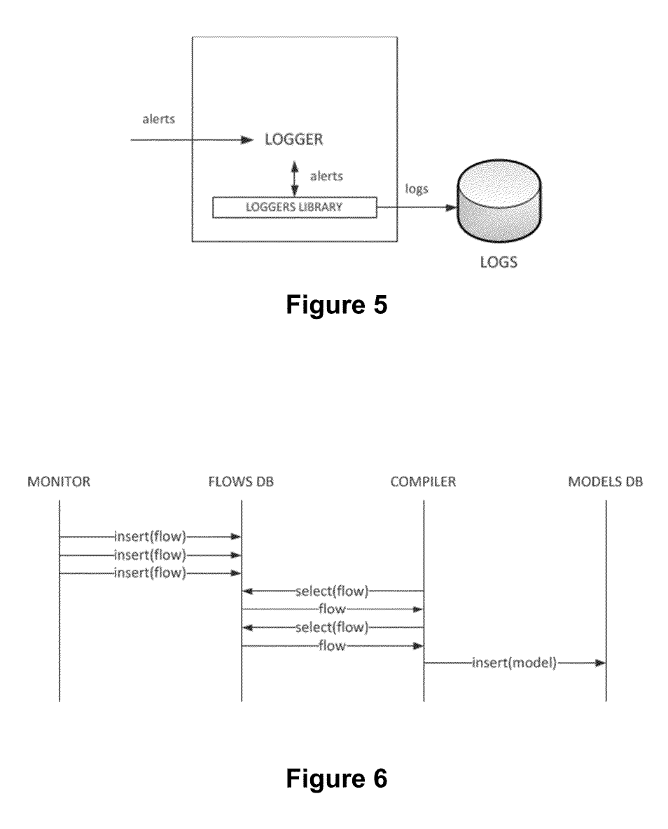

System components and the interaction between them were shown in FIG. 1. Clear grey boxes represented SoA components, dark grey one represented modified SoA and white boxes, including the detectors and compilers libraries, are innovative components within the architecture. Next, the system components will be detailed:

Probe

It is the single monitoring point, providing network traffic traces to the rest of the system components.

The anomaly detection performed by the Multi-algorithm ADS applications is based on network traffic, specifically searching for deviations from the normality in the TCP/IP packets traversing the monitored network. To do this it's necessary (1) to capture those packets from the physical media and (2) to prepare the captured packets for the detection algorithms, which usually work with aggregated flows (a flow is defined, at least, by the transport protocol—TCP or UDP —, the source and destination IP addresses and source and destination ports). The PROBE is the component in charge of packets capture and processing into flows, as shown in FIG. 2.

PROBES can also be legacy ones, for which are simply necessary to deploy an adapter in order to accomplish with the interface between PROBES and the MONITOR.

Monitor and Detectors Library

The MONITOR is the main controller of the system, receiving network traces from the PROBE and responsible for (1) traces storage if working in training mode and (2) DETECTORS invocation—passing them a copy of the traces—if working in detection mode. The DETECTORS LIBRARY is a collection of DETECTORS implementing each one a NADS algorithm.

Once the network traffic is aggregated into flows it is ready to be analyzed using a wide variety of anomaly detection algorithms. Nevertheless, it must be remembered that the traffic can be either stored (in order to build the normal models) either used by the detection algorithms. So, some entity must (1) know if the system is currently running in storing or detection mode and (2) forward the traffic to the storage component or to the detection entities depending on the running mode. The proposed invention implements this by means of the MONITOR.

Regarding the detection, since the algorithms portfolio cannot be complete (impossibility to implement all the existent algorithms, not already discovered algorithms) it would be very convenient to have a mechanism to tune the detection system (adding, removing or modifying algorithms). The system architecture provides such a pluggable mechanism by means of the DETECTORS LIBRARY. The DETECTORS LIBRARY is a discrete collection of detection algorithms, the current collection, having a defined interface with the MONITOR. A new detection algorithm—formerly, a DETECTOR—can be included into the collection if such DETECTOR respects the defined interface with the MONITOR. All the DETECTORS within the library have not to be always used, and if it exists the possibility to enumerate the desired subset of algorithms to the MONITOR. This can be done by means of configuration files, for example.

The MONITOR then simply forwards as previously said, through the defined interface, the received flows to all the DETECTORS within the DETECTORS LIBRARY. Finally, the DETECTORS compare the incoming flows with the stored normal behavior models.

The DETECTORS LIBARY is originally conceived, precisely, as a library that is natively incorporated to the MONITOR software (static or dynamic libraries in C/C++, JAR files in Java, etc). The purpose of this decision is to improve the flows delivery to the DETECTORS, but the developer can implement the library as a set of processes running independently of the MONITOR, for example; even, the DETECTORS can be placed in separated physical devices.

Compiler and Compiler Library

The COMPILER is responsible for COMPILERS invocation when the system works in training mode. It runs once the traces storing phase ends. The COMPILER LIBRARY is a collection of COMPILERS implementing each one a behavior modeling mechanism.

The COMPILER is the module of the Multi-algorithmic ADS architecture involved in the generation of normal behavior models and, thus, is the central component of the proposed invention. As known, anomaly detection algorithms generally compare the observed traffic with a normal model, searching for deviations between one and the other. Since the detection algorithms can be very different then their baseline models will also be very different in spite of the data used to generate them is the same (the captured and aggregated traffic). The COMPILER is responsible for generating these differentiated models generation through the COMPILERS LIBRARY, which contains one model generator—formerly, a COMPILER—per detection algorithm in the system. COMPILERS within the library can be enabled or disabled.

Nevertheless, the COMPILER is an optional component since some DETECTORS could not need a personalized model (a default model is always used independently of the specific behavior of the users); or the models can have been generated by other means; or even the DETECTOR does not need a model.

Logger and Loggers Library

The LOGGER receives alerts from the MONITOR and invokes the LOGGERS. The LOGGERS LIBRARY is a collection of LOGGERS implementing each one a logging facility.

Finally, the collaborative alarms generated can be logged, task for which the LOGGER component is introduced in the architecture (once more, an exhaustive logging portfolio is unaffordable, so a LOGGERS LIBRARY is used to dynamically add or remove logging facilities: files, databases, Syslog, etc). Existent LOGGERS could be enabled or disabled in the configuration.

Architecture Interfaces

Next, interfaces between the system components will be described:

Probe—Monitor

This interface defines how the flows generated at the PROBE component are sent to the MONITOR component. Communications, basically, can implement two different schemas depending on the PROBE proactively:

1. Proactive exchange: the PROBE sent the flows at the time they are ready to be shared.

2. On-demand exchange: the flows are sent when the MONITOR requests them. The use of one or other schema has an important impact on the real-time performance. On the one hand, it's obvious that on-demand exchange is not real-time compliant since the data forwarding depends on the availability of the MONITOR. On the other hand, it could be though that proactive exchange is always real-time compliant; but this could not be true if the MONITOR component do again a buffering of the proactively received data.

In any case, the format of the exchanged flows must be established in order to ensure the correct interaction between PROBES and MONITOR. If legacy sources of data are used then an adapter must be deployed in order to ensure its availability. A non-exhaustive list of fields that could be exchanged between PROBES and MONITOR is the following:
Layer 4 protocol (TCP, UDP, etc).
First and last packet timestamps.
Source and destination IP addresses in the flow.
Source and destination TCP or UDP ports in the flow.
Number of sent and received packets.
Number of sent and received bytes.
TCP state or, at least, TCP flags involved in the flow.
Certain application header data, such as DNS, HTTP, SMTP, SIP and others.

Monitor—Compiler

As stated in the specific MONITOR and COMPILER sections, the communication between these two components of the proposed invention architecture is done by means of databases. Two are the reasons for this:

1. The high amount of captured flows does not allow simple memory buffering.

2. Most of the anomaly detection algorithms need a wide time windows to perform their normal behavior models. Of course, real-time built of models is possible in some anomaly detection algorithms, but, since this task is not critical, it will always be done in a non real-time fashion.

The deployed database must allow the MONITOR to store the flows built in the exchange format agreed between the PROBE and the MONITOR (see previous section). These stored flows can be queried by the COMPILER as well, which will generate the models and store them in another database.

Monitor—Logger

The alarms generated by the MONITOR are sent to the LOGGER component in a specific format, for which candidate fields could be the following:
Identifier of the attacker.
Identifier of the attacked host.
Involved protocol.
Timestamp for the alert.
Type of attack/anomaly type.
DETECTOR identifier.
Feedback information such as original data causing the alarm rise at the DETECTOR, extended targets list (if there is not a unique one), etc.

Detectors

The system foresees the use of advanced algorithms to improve the efficacy of the anomaly detection systems. These advanced algorithms come from the artificial intelligence field, being the neural networks and the clustering algorithms the main candidates to be used.

Neural networks and other supervised machine learning algorithms [10] have demonstrated several times its power in classification problems, due to their capability to generalize solutions by means of a few training examples; their adaptability; and their low false positives rate.

However, it is not always is possible to use supervised algorithms, especially when there is not an expertise able to label or pre-classify the training examples. When this occurs, unsupervised algorithms [11] such as clustering are needed. Clustering is very useful in self-generation of classes of traffic, behaviors, etc.

A couple of DETECTORS being part of the DETECTORS LIBRARY are detailed here. These DETECTORS are examples of the advanced detection algorithms envisioned for proposed the Multi-algorithmic ADS. Other simple algorithms such as volumetric traffic monitoring, absolute counts of packets or flows between nodes, and periodic flows detection are not described since they are not innovative algorithms although they can perfectly be developed over the proposed invention.

Further DETECTORS not documented here could be added to the Multi-algorithmic ADS in the form of extensions of the current patent.

DNS-Based Domain-Flux Detector

This DETECTOR aims to detect domain-flux [12] 0activities in the monitored DNS traffic, which can denote the presence of a bot [7].

Bots within a botnet usually implements DNS queries in order to discover their command-and-control (C&C) server; this allows bots masters to change the real location (the IP address) of the server without reconfiguring their bots. While fixed FQDN's are easy to detect and filter, bots implement the domain-flux technique, which dynamically generate a high amount of FQDN's for the C&C server in order to synchronize with the master. These dynamically generated FQDN's can be based on the current timestamp, or they can be a set of pseudo-randomly generated ones, being only one of the possibilities the valid one. In any case, this technique generates a lot of NX_DOMAIN (and other) responses when querying the DNS server. This detector analyzes these anomalous responses.

Thus, DNS responses are analyzed and a set of features is extracted within an interval of time, being the following an example of features set:
Number of NX_DOMAIN responses.
Number of FORMAT_ERROR responses.
Number of REFUSED responses.
Number of SERVER_FAILURE responses.
Number of different queried FQDN's.
Number of one-layer FQDN's
Number of two-layer FQDN's.
Number of three-layer or more FQDN's.
Number of suspicious top-level-domains (TLD).
Number of layer two domains with length under 6.
Number of layer two domains with length over 5 and under 21.
Number of layer two domains with length over 20.
Number of layer two domains with number of vocals under 0.3%
Number of layer two domains with number of digits over 0.5%

These features compound a vector of characteristics that is evaluated using a neural network. This neural network is previously trained (supervised) using examples of vectors containing values for all the above features and providing an additional field, a label. This label will provide information regarding the convenience of raise an alarm or not when a similar vector is found in the traffic.

The DETECTOR uses, therefore, a unique pre-build default model—the specific neural network configuration resulting after the training phase.

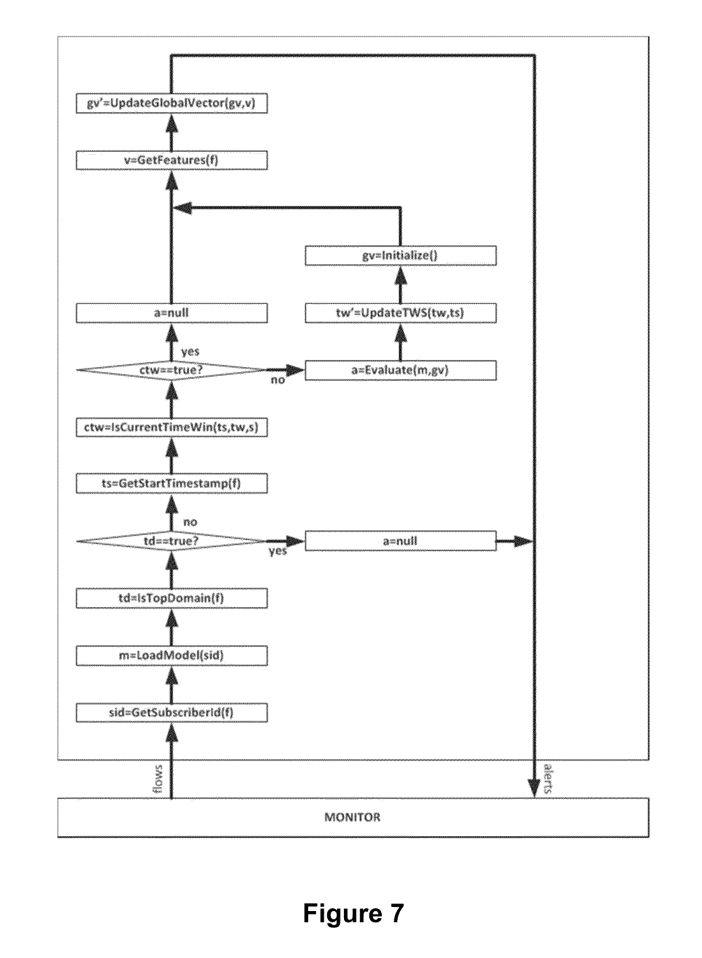

A flow chart was provided to illustrate the proposed DETECTOR in FIG. 7, wherein some variables are described in the following table:

| Variable | |
|---|---|
| name | Description |
| f | Flow |
| sid | Subscriber identifier |
| m | Model for the subscriber identifier (currently a default one) |
| td | Is the current flow related to a top domain? |
| ts | Timestamp for the current flow |
| tw | Start timestamp of the current time window |
| tw′ | Updated tw |
| s | Size of the time window |
| ctw | Is the current flow in the current time window? |
| a | Alert |
| v | Features vector get from the current flow |
| gv | Global accumulated vector regarding the current time window |
| gv′ | Updated gv |

Suspicious Traffic Clustering

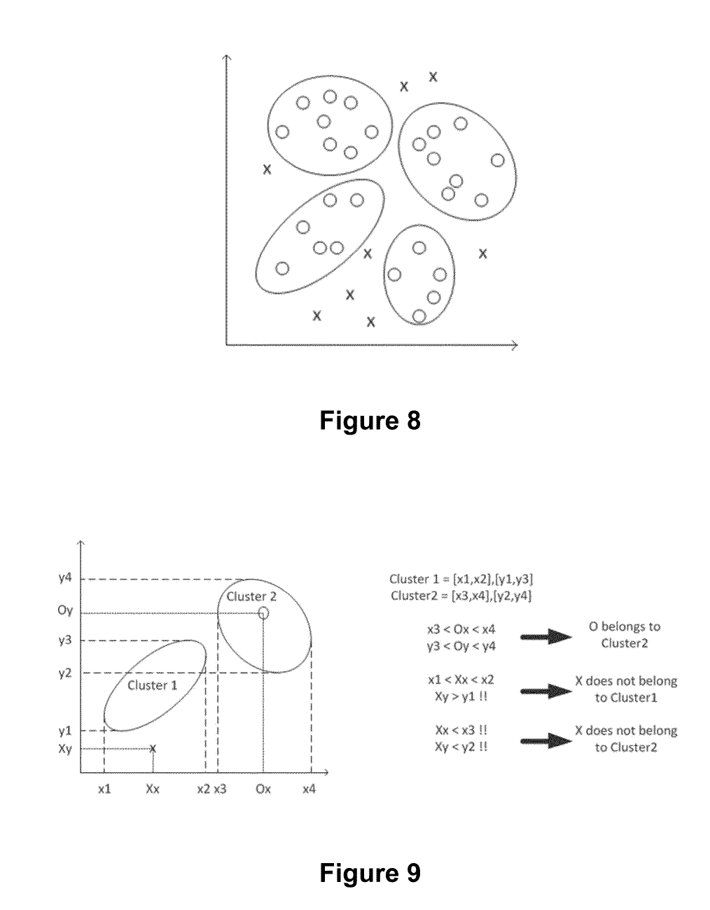

The basics of this DETECTOR rely in the building of a personalized model regarding the values of certain characteristics within an interval period. Unlike the previous DETECTOR, no expertise is used to train this one, i.e. an unsupervised algorithm is going to be used. Specifically, an Expectation-Maximization (EM) clustering algorithm [13] will define the classes of traffic each user is commonly involved in. Then, in a second step, anomalies will be detected if a pattern of traffic different from the normal ones appears. Graphically, this process was shown in the 2-features simplified picture of FIG. 8, where the circles represented clusters of data, the “o” represented a normal vector and a “x” was an anomaly:

However, the key point is not the algorithm but the features of the vectors that will feed the EM implementation. Features such as the number of packets/bytes/flows sent and received seem to be valid candidates, but these characteristics are not statistically stables over time. On the contrary, stable features are needed; better ones are those related, precisely, with abnormal behaviors. This DETECTOR considers at least the following ones (counts regard to an interval of time):
Number of flows having the destination located in a not-usual country.
Number of flows having the destination included in a black list.
Number of flows using a not-usual protocol.
Number of suspicious TCP flows (only SYN flows, only SYN+ACK flows, only FIN flows, only FIN+ACK flows).
Number of flows over 10 KB length.
Number of flows over 50 KB length.
Number of very little flows (under half MTU).
Number of flows not generated by the modeled entity.

Most of the above features should have nonzero values, but very close to zero, in the normal case. This is not relevant since a user can access one or two legitimate servers located in a not-usual country, for instance; the important thing is to find abnormal values.

Not usual countries and not-usual protocols are defined performing a previous statistic regarding top accessed countries ant top used protocols during certain time interval.

The flow chart for the suspicious traffic clustering DETECTOR is the same than in the DNS-base domain-flux DETECTOR one, but being the evaluation function a different one. In this case the evaluation function checks weather the accumulated vector maps any clusters within the model (is normal behavior) or not (is an anomaly). In this sense a quick cluster belonging algorithm is proposed.

Cluster belonging functions may be complex, especially when large feature vectors are used. Here a quick evaluation function is presented, based on a simplification of the obtained clusters: for each cluster and for each dimension or feature its boundaries are calculated, i.e. the minimum and maximum values the feature can take regarding the current cluster. Then, the cluster belonging function is as simple as checking if each feature within the evaluated vector is inside the boundaries of the cluster's same feature. The idea can be easily seen in a 2-features space, as shown in FIG. 9.

### Advantages of the Invention

1. Efficacy Advantages

Per-Entity and Per-Algorithm Basis Behavior Modeling

The proposed invention allows per-entity and per-algorithm based behavior modeling, addressing statistically little and sophisticated attacks that would not be detected in a per-network basis. Nevertheless, this Multi-algorithmic ADS allows too the definition of global behavior models.

Advanced Detection Algorithms

The algorithms detailed before are based on complex artificial intelligence and machine learning algorithms which provide flexible, self-adapting, self-learning and accuracy mechanisms to detect both general anomalies and traffic specific abnormal behaviors, such as domain-flux.

2. Efficiency Advantages

Common Framework for Monitoring Applications Developing

The architecture showed in this document aims to be a reference model when implementing collaborative detection systems, specifically collaborative anomaly detection applications. As seen in the previous State of the Art section, several attempts to define such kind of applications have led to a mess of concepts that do not help to know if an architecture has emerge from an algorithm or vice versa, and the worst, doing hard to integrate both new algorithms and new architecture requirements. The proposed system gives to developers a common framework to design new anomaly detection applications, but also to add those new applications to existing ones in an aseptic fashion. This is clearly an advantage to network administrators (mainly telecommunications operators) that want to include to their detection systems portfolio a new detection strategy or algorithm without interfering with the existing ones.

Processing Distribution

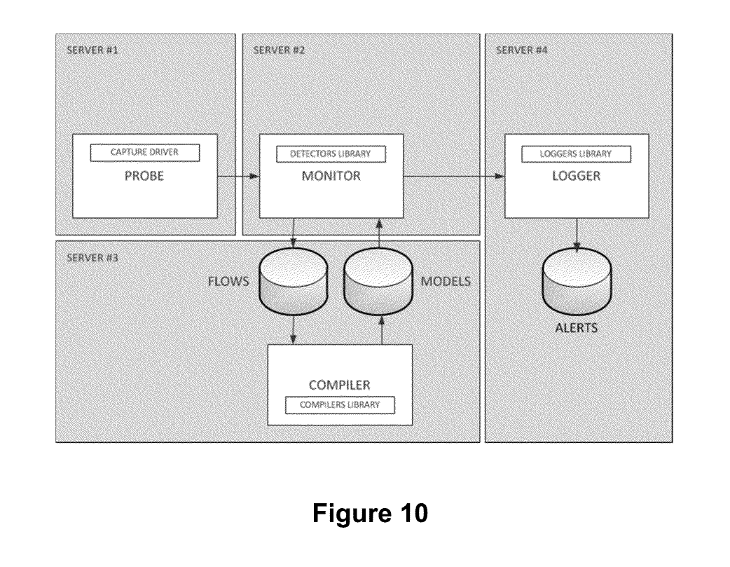

All the components of this architecture can be easily distributed among several physical devices; the single requirement is that the developer of the NADS implements the interfaces between modules using one of the many communications technologies such as sockets, web services, RPC, RMI, etc. FIG. 10 showed an example of such distributed deployment within four different servers.

Processing distribution also aids in the scalability of the developed system, since the inclusion of a heavy-processing algorithm may be solve, for example, including a dedicated server for those detection algorithm and implementing a TCP/IP-based interface with the MONITOR.

Single Monitoring Point for a Wide Variety of Applications

The reader must have into account that monitoring points are limited due to technical constraints (fibber taps make weaker the optical signal when dividing it; port mirroring at routers or switches consume lot of resources that can be subtracted to traffic processing; or directly the business cannot be stopped by cutting the line, after all, either physical tapping or logical mirroring must be performed). As seen, the Multi-algorithmic ADS just needs one single monitoring point common to all the deployed applications.

Legacy Probes Integration

The PROBE component does not need to be developed from the scratch. Many others well-known flow generation systems such as Netflow [8] can be used. The only requirement to do such integration is to include a normalization step.

A person skilled in the art could introduce changes and modifications in the embodiments described without departing from the scope of the invention as it is defined in the attached claims.

### ACRONYMS

ADS Anomaly Detection System
AI Artificial Intelligence
CPU Central Processing Unit
C&C Command and Control
DNS Domain Name System
DoS Denial of Service
EM Expectation-Maximization
FQDN Fully Qualified Domain Name
HTTP Hyper-Test Transfer Protocol
IP Internet Protocol
IDS Intrusion Detection System
ISP Internet Service Provider
KB Kilo Bytes
MTU Maximum Transfer Unit
NADS Network Anomaly Detection System
NIDS Network Intrusion Detection System
RAM Random Access Memory
SIEM Security Information and Events Management
SMTP Simple Mail Transfer Protocol
SOA Service Oriented Architecture
TCP Transport Control Protocol
TLD Top Layer Domain
UDP User Datagram Protocol

### REFERENCES

[1] Snort IDS. http://www.snort.org/
[2] Bro IDS. http://bro-ids.org/
[3] “Spambot” at Wikipedia. http://en.wikipedia.org/wiki/Spambot
[4] “Denial-of-service attack” at Wikipedia. http://en.wikipedia.org/wiki/Denial-of-service_attack
[5] “Port scanner” at Wikipedia. http://en.wikipedia.org/wiki/Port_scanner
[6] Proventia ADS by IBM. http://www-935.ibm.com/services/uk/index.wss/offering/iss/y1026942
[7] “Botnets” at Wikipedia. http://en.wikipedia.org/wiki/Botnets
[8] Cisco IOS NetFlow. http://www.cisco.com/en/US/products/ps6601/products_ios_protocol_group_home.html
[9] “SEM” at Wikipedia. http://en.wikipedia.org/wiki/Security_event_manager
[10] “Supervised learning” at Wikipedia. http://en.wikipedia.org/wiki/Supervised_learning
[11] “Unsupervised learning” at Wikipedia. http://en.wikipedia.org/wiki/Unsupervised_learning
[12] “Fast-flux” at Wikipedia. http://en.wikipedia.org/wiki/Fast_flux
[13] “Expectation-maximization algorithm” at Wikipedia http://en.wikipedia.org/wiki/Expectation-maximization_algorithm
[14] “Anomaly detection” at Wikipedia http://en.wikipedia.org/wiki/Anomaly_detection
[15] “Intrusion detection system” at Wikipedia http://en.wikipedia.org/wiki/Intrusion-detection_system

1-21. (canceled)

22. A method to detect malicious software, said detection being performed in an Anomaly Detection System, or ADS, by analyzing the behavior of a network and looking for deviations with respect to a normality, said normality indicating common behavior of users of said network and being defined previous to said detection, the method comprising:
building a plurality of detection models for each one of a plurality of different entities of said network, each of said plurality of detection models adapted to said different entities of said network and to different algorithms, said different algorithms implementing different detection strategies and said plurality of detection models representing said normality; and
representing said plurality of detection models in a two-dimensional matrix, one dimension of said matrix corresponding to a number of said different entities comprising said network and other dimension of said matrix corresponding to a number of said different algorithms employed.

23. The method according to claim 22, comprising monitoring traffic of said network, said traffic comprising packets traversing said network, and preparing said packets for said different algorithms, or for said different detection strategies, by aggregating said packets into flows.

24. The method according to claim 23, comprising storing said traffic in order to build said plurality of detection models when said ADS is operating in storing mode.

25. The method according to claim 23, comprising:
processing said flows according to at least part of said different algorithms when said ADS is operating in detection mode, said different algorithms being defined in a detectors library, said detectors library at least allowing adding, removing or modifying algorithms; and
comparing said flows processed with at least part of said plurality of detection models.

26. The method according to claim 25, comprising:
storing said traffic in order to build said plurality of detection models when said ADS is operating in storing mode;
building said plurality of detection models according to a compilers library which contains one model generator per algorithm, each model generator defining a compiler to be used with said traffic stored when operating in said storing mode.

27. The method according to claim 26, comprising having a default model generator contained in said compilers library to build at least part of said plurality of detection models.

28. The method according to claim 25, comprising logging alarms generated when detecting said malicious software according to said comparison between said flows processed with said at least part of said different algorithms and said at least part of said plurality of detection models.

29. The method according to claim 28, wherein said alarms contain at least part of information of the following non closed list: identifier of attacker, identifier of attacked host, involved protocol, timestamp for the alert, type of attack or anomaly type, algorithm identifier and feedback information.

30. The method according to claim 29, wherein said different algorithms are defined according to neural networks, supervised machine learning algorithms, clustering algorithms and/or simple algorithms of the following non closed list: volumetric traffic monitoring, absolute counts of packets or flows between nodes and periodic flows detection.

31. The method according to claim 30, comprising implementing a given algorithm according to a Domain Name System, or DNS, based domain-flux detector, said given algorithm detecting domain-flux activities in a monitored DNS traffic by analyzing DNS responses, said analysis of DNS responses comprising:
extracting a plurality of features from said DNS responses;
building a vector of characteristics with said plurality of features;
evaluating said vector of characteristics using a neural network, said neural network being previously trained with examples of vectors; and
providing, said neural network, a label indicating the convenience to raise an alarm according to said evaluation.

32. The method according to claim 31, wherein at least part of said plurality of features are contained in the following non closed list: number of NX_DOMAIN responses, number of FORMAT_ERROR responses, number of REFUSED responses, number of SERVER_FAILURES responses, number of different queried FQDNs, number of one-layer FQDNs, number of two-layer FQDNs, number of three-layer or more FQDNs, number of suspicious top-level domains, number of layer two domains with length under 6, number of layer two domains with length over 5 and under 21, number of layer two domains with length over 20, number of layer two domains with number of vocals under 0.3% and number of layer two domains with number of digits over 0.5%.

33. The method according to claim 29, comprising implementing a concrete algorithm according to an Expectation-Maximization clustering algorithm, wherein said concrete algorithm identifies classes of traffic, groups said classes of traffic in clusters and detects an anomaly if it appears a pattern of traffic not belonging to one of said clusters.

34. The method according to claim 33, comprising feeding said concrete algorithm with a vector of features of said flows, said features being stable over time and being contained in the following non closed list: number of flows having destination located in a not-usual country, number of flows having destination in a black list, number of flows using a not-usual protocol, number of suspicious TCP flows, number of flows over 10 KB length, number of flows over 50 KB length, number of flows under half Maximum Transmission Unit and number of flows not generated by a modelled entity, wherein said suspicious TCP flows comprise only SYN flows, only SYN+ACK flows, only FIN flows and only FIN+ACK flows.

35. The method according to claim 34, comprising calculating boundaries of each of said clusters or of each feature of said vector of features, and detecting an anomaly if a value of a feature of each vector of features is outside the boundaries of corresponding cluster or corresponding feature of said vector of features.

36. A system to detect malicious software, said detection being performed in an Anomaly Detection System, or ADS, by analyzing the behavior of a network and looking for deviations with respect to a normality, said normality indicating common reality of said network and being defined previous to said detection, the system comprises a probe module for traffic monitoring of said network connected to a controller module in charge of performing said detection, wherein said controller module is provided of a plurality of detection models built by means of a compiler module for each one of a plurality of different entities of said network, each of said plurality of detection models adapted to said different entities of said network and to different algorithms, said different algorithms implementing different detection strategies and said plurality of detection models representing said normality.

37. The system according to claim 36, wherein a first interface between said probe module and said controller module allows sending traces of traffic in the form of flows from said probe monitor to said controller module every time that said flows are ready to be shared or when said controller module requests said flows.

38. The system according to claim 37, wherein said probe module adapts said traces of traffic to flows and allows availability in said flows of at least part of the following fields: layer 4 protocol, first and last packet timestamps, source and destination IP addresses in the flow, number of sent and received packets, number of sent and received bytes, TCP flags involved in the flow and application header data.

39. The system according to claim 36, wherein said controller module is provided with a flows database wherein at least said flows are stored and said compiler module is provided with a models database wherein at least said plurality of detections models is stored.

40. The system according to claim 39, wherein a second interface is deployed between said controller module and said compiler module in order to allow communication between said controller module and said flows database, between said flows database and said compiler module and between said compiler module and said models database.

41. The system according to claim 36, wherein a logger module connected to said controller module is provided in order to log alarms generated by said controller module when detecting said malicious software, said controller module and said logger module being communicated by means of a third interface.

42. The system according to claim 41, wherein said probe module, said controller module, said compiler module and/or said logger module are distributed in different physical devices or servers, said first interface, said second interface and/or said third interface using at least one of the communication technologies of the following non closed list: sockets, web services, rcp commands and Remote Method Invocation.
